(19) United States
(12) Patent Application Publication
(10) Pub. No.: US 2026/0341727 A1
(43) Pub. Date: Oct. 29, 2026

(54) CATHODE ACTIVE MATERIAL AND SECONDARY BATTERY COMPRISING SAME

(71) Applicant: L&F CO., LTD., Daegu (KR)

(72) Inventors: Han Ah KIM, Daegu (KR); Seul Gi JEON, Daegu (KR); Gi Hwan CHANG, Daegu (KR); Jae Joon JO, Daegu (KR); Hwa Young SON, Daegu (KR)

(21) Appl. No.: 19/110,949

(22) PCT Filed: Nov. 23, 2023
(86) PCT No.: PCT/KR2023/018982

§ 371 Date: Mar. 12, 2025

(30) Foreign Application Priority Data
Dec. 9, 2022 (KR) 10-2022-0171958

(51) Int. Cl. H01M 4/62; H01M 4/36; H01M 4/525; H01M 10/0525

(52) U.S. Cl. CPC H01M 4/628; H01M 4/366; H01M 4/525; H01M 10/0525

(57) ABSTRACT

The present invention provides a cathode active material that includes a core containing a transition metal oxide, a first surface portion formed outward from the interface of the core, and a second surface portion formed inward from the interface of the core, wherein both the first and second surface portions contain Si. The invention also provides a secondary battery that includes this cathode active material.

### TECHNICAL FIELD

The present invention relates to a cathode active material, and more specifically, to a cathode active material comprising a core including a transition metal oxide and surface portions formed in both outward and inward directions from the interface of the core, wherein the surface portions contain Si, and a secondary battery including the same.

### BACKGROUND ART

Lithium secondary batteries have high energy density and long lifespan, making them widely used not only in small portable electronic devices such as laptops, mobile phones, and digital cameras but also in medium- to large-scale devices, including hybrid electric vehicles (HEVs), electric vehicles (EVs), and energy storage systems (ESSs).

As lithium secondary batteries are utilized in both small portable devices and medium- to large-scale devices, active materials capable of achieving high energy density are in demand. To achieve higher energy density compared to conventional active materials, technological developments related to high-Ni active materials with a nickel content of 70% or more have been actively pursued.

Typically, cathode active material particles used in lithium secondary batteries have a secondary particle structure in which fine submicron-sized primary particles are agglomerated into micron-sized secondary particles. However, this secondary particle structure has the drawback of degradation in battery performance due to the separation of primary particles from the agglomerated structure during repeated charge-discharge cycles, causing the secondary particles to break. Since this issue is attributed to the structural characteristics of secondary particles, solving it without altering the structure is challenging. Therefore, a new type of cathode active material with a single particle (one-body particle) structure has been developed.

Such one-body particle active materials have a structure that consists of a single, non-agglomerated primary particle rather than an agglomeration of primary particles into a secondary particle structure. Since there is “almost” no agglomeration, particle separation due to charge-discharge cycles is prevented, thus resolving issues associated with secondary particle active materials. Here, the term “almost” accounts for the unavoidable presence of slight agglomerations during the manufacturing process of one-body particle/powder materials. Due to technical limitations, it is impossible to ensure that all particles exist in a perfectly separated state, so some degree of unintentional agglomeration is allowed, with the proportion of agglomerated particles being within 30% of the total active material powder. These slightly agglomerated particles are not classified as conventional secondary particles.

Unlike conventional secondary particles, one-body particles have a micron-scale size as a single particle. Since they do not have an agglomerated structure, they do not undergo particle separation during charge-discharge cycles, fundamentally solving the problem associated with secondary particle structures.

However, while secondary particle active materials have long been commercialized and applied in various industrial fields, one-body particle active materials face significant challenges in ensuring stable properties and are still mainly used for research purposes.

In particular, one-body particle active materials require high sintering temperatures, making it extremely difficult to secure stable properties, and their structural instability increases dramatically as the Ni content rises above 70% (high-Ni), leading to severe degradation in performance.

Another major issue is oxygen desorption caused by high sintering temperatures. Oxygen desorption occurs when oxygen is removed from the structure of the cathode active material, leading to excessive formation of a rock-salt NiO structure and an increase in lithium byproducts. With repeated charge-discharge cycles, the proportion of NiO structure gradually increases, raising resistance and leading to capacity degradation and gas generation, causing deterioration in battery performance.

Oxygen desorption is influenced by sintering temperature and the Ni content in the active material. When the Ni content in the active material is high, structural instability exacerbates the degradation caused by oxygen desorption.

To achieve the one-body particle structure, sintering at a high temperature of around 850 to 1000 °C is required, and to achieve the theoretical high capacity of cathode active materials, it is necessary to develop active materials with a Ni content of 70% or more (high-Ni). This makes controlling oxygen desorption even more challenging. Most oxygen desorption occurs at the surface of one-body particles, leading to an unstable surface structure, including the formation of NiO structures and an increase in lithium byproducts.

Therefore, there is a high demand for technologies that can enhance the structural stability of active materials and address issues such as oxygen desorption to improve their overall performance effectively.

### DISCLOSURE

### Technical Problem

The present invention aims to solve the aforementioned problems of conventional technologies and address technical challenges that have long been requested in the field.

After extensive research and numerous experiments, the inventors of this application successfully developed novel cathode active materials that include a core and surface portions with specific compositions and structures. These cathode active materials not only solve the problems of increased resistance and capacity reduction caused by the formation of a chemically stoichiometric rock-salt NiO structure due to oxygen desorption but also address the issue of battery lifespan degradation caused by surface damage of the active material due to side reactions with the electrolyte. Based on these findings, the present invention was completed.

### Technical Solution

Accordingly, the cathode active material according to the present invention comprises:
a core including a transition metal oxide;
a first surface portion formed in an outward direction from the interface of the core; and
a second surface portion formed in an inward direction from the interface of the core;
wherein both the first and second surface portions include Si.

In general surface treatment, an outer coating layer formed outward from the core surface can prevent side reactions on the active material surface and improve capacity and lifespan. However, in the case of one-body particles with high Ni content (high-Ni) that require high sintering temperatures during manufacturing, an external coating layer alone cannot prevent oxygen desorption, leading to an unstable inner surface layer of the active material.

To address this issue, the present invention provides surface portions containing Si, which has a high oxygen bonding strength. These surface portions simultaneously include a first surface portion formed in the outward direction from the core's interface and a second surface portion formed in the inward direction from the core's interface.

Si is an element with high oxygen bonding strength and can react with lithium to form lithium compounds. Additionally, while unreacted elements remaining in an inactive state could act as resistance and degrade the electrochemical properties of the active material, some Si-based oxides, when present on the particle surface as the first surface portion, can react with HF generated from side reactions with the electrolyte, thereby suppressing gas generation and preventing damage to the active material surface.

Furthermore, the second surface portion of the present invention suppresses the oxygen desorption phenomenon occurring at the surface by allowing externally introduced oxygen to diffuse into the core, facilitating the recombination of lithium and oxygen. Consequently, the unstable crystal structure stabilizes, residual lithium decreases, and capacity, efficiency, and lifespan characteristics are enhanced.

In one specific example, the transition metal oxide in the core may have an elemental composition represented by the following Chemical Formula 1:

AₓM_{1-y}D_{y}O_{2-z}Q_{z} (1)
wherein:
A represents one or more elements selected from alkali metals;
M represents one or more transition metal elements stable in four-coordinate or six-coordinate system;
D represents one or more elements selected from alkali earth metals, transition metals, or non-metals as dopants; and
Q represents an anion including one or more elements selected from F, S, and P;
with 0.35≤x≤1.1, 0≤y≤0.1, and 0≤z≤0.2.

For example, representative alkali metals (A) include Li and Na, preferably Li.

The transition metal (M) includes, for example, one or more of Ni, Co, and Mn, with a preferably Ni content of at least 70 mol %, more preferably at least 80 mol %. When the Ni content exceeds this range based on the total transition metal content, the oxygen desorption is more severe; however, the first and second surface portions as defined herein can depress the oxygen desorption and surface stability, thereby more effectively enhancing resistance, capacity, efficiency, residual lithium, and cycle-life.

Representative dopants (D) include Al, Zr, Mg, B, Ti, P, Si, Zn, Sn, Ca, Ge, Ga, Nb, Mo, and W.

In one specific example, it is more effective if the dopant D includes at least one element selected from Al and Zr.

Al is an element with an ionic radius similar to that of Ni³⁺ of 6 coordination in the transition metal layer of the active material. For example, the ionic radius of Al³⁺ (6 coordination) is 0.535 Å, which is comparable to the 0.56 Å radius of Ni³⁺ (6 coordination), making substitution feasible. Since Ni in the +3 oxidation state has an electronically unstable structure, doping Al³⁺ into Ni³⁺ sites can effectively improve the lifespan characteristics of the active material.

In the case of Zr, it is an element with an ionic radius similar to that of Li⁺ in the transition metal layer of the active material. For example, Zr⁴⁺ (6 coordination) having an ionic radius of 0.72 Å can be applied. This ion can be doped into the 3a octahedral site of the Li layer, enhancing structural stability, thereby making it more effective in achieving the desired effects of the present invention.

The transition metal oxide of the present invention can have various crystal structures, including, for example, an α-NaFeO₂ layered crystal structure.

The specific examples of the first and second surface portions will now be described with three examples.

In the first example, the second surface portion includes the elemental composition represented by Chemical Formula 2 and the first surface portion includes the elemental composition represented by Chemical Formula 3:

AₐM_{1-b-c}D_{b}Si_{c}Oₖ (2)
wherein:
A represents one or more elements selected from alkali metals;
M represents one or more transition metal elements stable in four-coordinate or six-coordinate system;
D represents one or more elements selected from alkali earth metals, transition metals, or non-metals used as dopants;
Q represents an anion including one or more elements selected from F, S, and P; with 0.35≤a≤1.1, 0≤b≤0.1, 0<c≤0.1, and 0<k≤4, and

A_{d}SiₑO_{f} (3)
wherein:
A represents one or more elements selected from alkali metals;
1≤d≤8, 1≤e≤2, and 0≤f≤6.

The details of A, M, D, etc., in Chemical Formulas 2 and 3 can be referenced from the description of Chemical Formula 1, and the same applies to the subsequent Chemical Formulas.

In the second example, the second surface portion includes the elemental composition represented by Chemical Formula 2 and the first surface portion includes the elemental composition represented by Chemical Formula 4:

AₐM_{1-b-c}D_{b}Si_{c}Oₖ (2)
wherein:
A represents one or more elements selected from alkali metals;
M represents one or more transition metal elements stable in four-coordinate or six-coordinate system;
D represents one or more elements selected from alkali earth metals, transition metals, or non-metals as dopants;
Q represents an anion including one or more elements selected from F, S, and P;
with 0.35≤a≤1.1, 0≤b≤0.1, 0<c≤0.1, 0<k≤4, and

Si_{g}Oₕ (4)
wherein 1≤g≤2 and 1≤h≤4.

In the third example, the second surface portion includes the elemental composition represented by Chemical Formula 2 and the first surface portion simultaneously includes the elemental compositions represented by Chemical Formulas 3 and 4:

AₐM_{1-b-c}D_{b}Si_{c}Oₖ (2)
wherein:
A represents one or more elements selected from alkali metals;
M represents one or more transition metal elements stable in four-coordinate or six-coordinate system;
D represents one or more elements selected from alkali earth metals, transition metals, or non-metals as dopants;
Q represents an anion including one or more elements selected from F, S, and P;
with 0.35≤a≤1.1, 0≤b≤0.1, 0<c≤0.1, and 0<k≤4, and

A_{d}SiₑO_{f} (3)
wherein
A represents one or more alkali metal elements;
1≤d≤8, 1≤e≤2, 0≤f≤6, and

Si_{g}Oₕ (4)
wherein 1≤g≤2 and 2≤h≤4.

In these three examples, when the alkali metal (A) is Li, schematic cross-sectional shapes of the active material particles are shown in FIG. 5. As depicted in FIG. 5, from the interface of the core having the composition of LiₓM_{1-y}D_{y}O_{2-z}Q_{z}, a single first surface portion with the composition of either Li_{d}SiₑO_{f} or Si_{g}Oₕ may be formed in the outward direction, or a composite first surface portion having both the elemental compositions of Li_{d}SiₑO_{f} and Si_{g}Oₕ may be formed; and in the inward direction from the core interface, a single second surface portion having the composition of LiₐM_{1-b-c}D_{b}Si_{c}Oₖ may be formed.

For ease of understanding, each surface portion is represented as a complete circular shape; however, it is also possible for certain areas to be partially deficient. Additionally, the thickness of the surface portions has been depicted arbitrarily. Therefore, the shapes illustrated in the drawings should not be interpreted as limiting the scope of the present invention.

The first surface portion may have various morphologies depending on its elemental composition.

In the first example, the first surface portion may have a relatively higher proportion of crystalline regions. When the first surface portion has the elemental composition of Chemical Formula 3, the crystalline region may occupy a significant portion. Therefore, the first surface portion may include at least one selected from Li₂SiO₃, Li₄SiO₄, Li₈SiO₆, and LiSi as defined by Chemical Formula 3.

The first surface portion that includes the elemental composition of Chemical Formula 3 can form a strong chemical bond with the core surface based on its crystalline structure. This chemical bonding can effectively suppress structural instability, such as oxygen desorption.

In the second example, the first surface portion may have a relatively higher proportion of amorphous regions. When the first surface portion has the elemental composition of Chemical Formula 4, the amorphous region may take up a large portion. Therefore, the first surface portion may include at least one selected from SiO₂ and Si₂O₄ as defined by Chemical Formula 4.

The first surface portion that includes the elemental composition of Chemical Formula 4 has an amorphous structure, which provides higher spreadability due to its low degree of crystallization. This allows it to effectively coat the core surface, thereby suppressing side reactions with the electrolyte.

Among the compositions of Chemical Formula 4, SiO₂ does not react with lithium and remains on the surface of the active material. During electrochemical reactions, it can react with HF generated from electrolyte side reactions according to the following reaction equation, forming SiF₄:

SiO₂+4HF→SiF₄+2H₂O

As a result, harmful HF, which is detrimental to the active material, is consumed, and a protective layer containing SiF₄ is formed. This prevents surface damage to the active material, thereby improving capacity, efficiency, and lifespan characteristics.

However, it may be more desirable for the first surface portion to simultaneously contain the elemental compositions of both Chemical Formula 3 and Chemical Formula 4. If both are included (for example, as in the third structural example illustrated in FIG. 5), improvements in oxygen desorption suppression and surface stability can be achieved more effectively.

Additionally, in cases where crystalline and amorphous structures coexist, the spreadability of the highly crystalline structure from Chemical Formula 3 is relatively lower; however, the high spreadability of the amorphous structure from Chemical Formula 4 can help minimize uncoated areas in the first surface portion.

The thicknesses of the first and second surface portions are not particularly limited as long as they effectively achieve the intended improvements. For example, based on the average radius (r) of the core, the thickness of each surface portion may be 20% or less, preferably 10% or less. The minimum thickness may be at least 0.01%, preferably at least 0.1% of the core radius.

As demonstrated in the experimental results of Examples 11 and 12, the present invention applies not only to one-body particle active materials but also to clustered active materials, in which multiple primary particles are agglomerated.

In one specific example, the cathode active material according to the present invention may be configured to satisfy the condition that the Si content is 2 wt % or less when analyzed under the following ICP (Inductively Coupled Plasma) measurement conditions.

### [ICP Measurement Conditions]

Instrument: Perkin Elmer Optima, Avio

Electronic balance: approximately 0.1 mg

Pre-treatment: Sinter on a hot plate at 250 °C for 30 minutes, then dilute 250 times with ultrapure water.

If the Si content exceeds 2 wt %, the first surface portion may become excessively thick, making it difficult to achieve the intended effects of the first surface portion as designed in the present invention. Preferably, the Si content should be in the range of 0.1 to 1.5 wt %, and more preferably, in the range of 0.3 to 1.0 wt %.

In another specific example, the cathode active material according to the present invention may be configured to satisfy the condition that the average primary particle size of the core is 1 μm or more when measured in four randomly selected areas under the following SEM measurement conditions.

### [SEM Measurement Conditions]

Model: HITACHI (S-4800)

Resolution: 1.0 nm at 15 kV, 1.5 nm at 1 kV

Magnification: ×10,000

Electron Gun: Cold-cathode field emission type electron gun

Accelerating Voltage: 10 kV

Detector: SE (BSE).

The method for producing the cathode active material according to the present invention can be fully understood by those skilled in the art through the manufacturing examples and experimental examples described later. Specifically, to ensure the formation of both the first surface portion and the second surface portion around the interface of the manufactured cathode active material core, a Si-containing raw material, such as SiO₂, is added, followed by heat treatment within a temperature range of 300 to 700 °C, preferably 350 to 650 °C. In the experimental examples provided below, specific heat treatment temperatures of 450 °C and 600 °C are exemplified.

Additionally, the present invention provides a secondary battery including the above cathode active material. Depending on the type of alkali metal, the type of secondary battery may also vary. Among them, lithium-based secondary batteries are widely used. Since the structure and manufacturing method of such secondary batteries are well known in the industry, detailed descriptions are omitted in this specification.

### Effects of the Invention

As described above, the cathode active material according to the present invention effectively addresses the issues associated with high-Ni one-body particle cathode materials, such as resistance increase and capacity reduction caused by the stoichiometric formation of rock-salt structured NiO due to oxygen desorption. Additionally, it mitigates surface degradation of the active material caused by side reactions with the electrolyte, thereby improving battery lifespan.

### DESCRIPTION OF THE DRAWINGS

FIG. 1: SEM images of cathode active materials from Comparative Examples 11, 12, and Examples 8, 9, and 10 in Experimental Example 1.

FIG. 2: TEM images and EDS mapping images of cathode active materials manufactured in Comparative Examples 11, 12, and Example 8 in Experimental Example 2.

FIG. 3: High-resolution TEM images of cathode active materials from Example 8 and Comparative Example 11 in Experimental Example.

FIG. 4: XRD analysis graphs of cathode active materials manufactured in Comparative Examples 4, 11, 12 and Example 8 in Experimental Example 3.

FIG. 5: Schematic cross-sectional views of active material particles based on three examples of surface portions when the alkali metal (A) is Li according to the present invention.

### BEST MODE

Now, the present invention will be described in more detail with reference to the following examples. These examples should not be construed as limiting the scope of the present invention.

### Manufacturing Example 1

Using NiSO₄ as a Ni source, CoSO₄ as a Co source, and MnSO₄ as a Mn source in a molar ratio of 75:15:10, an aqueous solution was prepared in a 1000 L cylindrical reactor. While stirring in a co-precipitation reactor, an ammonia solution was slowly added to adjust the ammonia concentration to 3,000~6,000 ppm, and the reaction mixture was stirred at 50~60 °C for 10 hours.

The precipitate was filtered and dried at 100~120 °C for 18 hours to produce a cathode active material precursor of (Ni_{0.75}Co_{0.15}Mn_{0.1})(OH)₂.

### Manufacturing Example 2

The method for preparing the cathode active material precursor is generally the same as in Manufacturing Example 1, but the precursor was produced with a Ni, Co, and Mn ratio of 88:04:08.

### Manufacturing Example 3

The method for preparing the cathode active material precursor is generally the same as in Manufacturing Example 1, but the precursor was produced with a Ni, Co, and Mn ratio of 93:05:02.

### Manufacturing Example 4

The method for preparing the cathode active material precursor is generally the same as in Manufacturing Example 1, but the precursor was produced with a Ni, Co, and Mn ratio of 83:08:09.

### Manufacturing Example 5

The method for preparing the cathode active material precursor is generally the same as in Manufacturing Example 1, but the precursor was produced with a Ni, Co, and Mn ratio of 92:05:03.

### Comparative Example 1

Using the precursor from Manufacturing Example 1, LiOH was mixed in a 50 L powder mixer (HDSM-I-50, HANtech) at a Li/Metal ratio of 0.97; additionally, ZrO₂ (2000 ppm) and Al(OH)₃ (2000 ppm) were added and the mixture was stirred at 2000 rpm for 20 minutes. The mixture was then loaded into a roller-heated kiln (RHK) and sintered at 930 °C for 20 hours under an oxygen atmosphere, then cooled at room temperature to produce a cathode active material having an average primary particle size of 1 μm or more.

### Comparative Example 2

Using the precursor obtained in Manufacturing Example 2, the cathode active material was produced using the same method as in Comparative Example 1, except that it was sintered at 910 °C.

### Comparative Example 3

The cathode active material was produced using the same method as in Comparative Example 2, except that TiO₂ 2000 ppm was added instead of ZrO₂ 2000 ppm.

### Comparative Example 4

Using the precursor obtained in Manufacturing Example 3, the cathode active material was produced using the same method as in Comparative Example 1, except that it was sintered at 890 °C.

### Comparative Example 5

Using the precursor obtained in Manufacturing Example 4, the cathode active material was produced using the same method as in Comparative Example 1, except that it was sintered at 780 °C.

### Comparative Example 6

Using the precursor obtained in Manufacturing Example 5, the cathode active material was produced using the same method as in Comparative Example 1, except that it was sintered at 730 °C.

### Comparative Example 7

The cathode active material from Comparative Example 1, after the first sintering, was mixed with 0.5 wt % SiO₂ using a 30 L powder mixer at 1000 rpm for 30 minutes, then sintered at 300 °C for 10 hours to form the first surface portion.

### Comparative Example 8

The cathode active material from Comparative Example 1, after the first sintering, was mixed with 0.5 wt % SiO₂ using a 30 L powder mixer at 1500 rpm for 30 minutes, then sintered at 750 °C for 10 hours to form the second surface portion.

### Comparative Example 9

The cathode active material from Comparative Example 2, after the first sintering, was mixed with 0.5 wt % SiO₂ using a 30 L powder mixer at 1000 rpm for 30 minutes, then sintered at 300 °C for 10 hours to form the first surface portion.

### Comparative Example 10

The cathode active material from Comparative Example 2, after the first sintering, was mixed with 0.5 wt % SiO₂ using a 30 L powder mixer at 1500 rpm for 30 minutes, then sintered at 750 °C for 10 hours to form the second surface portion.

### Comparative Example 11

The cathode active material from Comparative Example 4, after the first sintering, was mixed with 0.5 wt % SiO₂ using a 30 L powder mixer at 1000 rpm for 30 minutes, then sintered at 300 °C for 10 hours to form the first surface portion.

### Comparative Example 12

The cathode active material from Comparative Example 4, after the first sintering, was mixed with 0.5 wt % SiO₂ using a 30 L powder mixer at 1500 rpm for 30 minutes, then sintered at 750 °C for 10 hours to form the second surface portion.

### Example 1

The cathode active material from Comparative Example 1, after the first sintering, was mixed with 0.5 wt % SiO₂ using a 30 L powder mixer at 1000 rpm for 30 minutes, then sintered at 600 °C for 10 hours to form both the first and second surface portions.

### Example 2

The cathode active material from Comparative Example 2, after the first sintering, was mixed with 0.5 wt % SiO₂ using a 30 L powder mixer at 1000 rpm for 30 minutes, then sintered at 450 °C for 10 hours to form both the first and second surface portions.

### Example 3

The cathode active material from Comparative Example 2, after the first sintering, was mixed with 0.5 wt % SiO₂ using a 30 L powder mixer at 1000 rpm for 30 minutes, then sintered at 600 °C for 20 hours to form both the first and second surface portions.

### Example 4

The cathode active material from Comparative Example 2, after the first sintering, was mixed with 0.5 wt % SiO₂ using a 30 L powder mixer at 1000 rpm for 30 minutes, then sintered at 600 °C for 10 hours to form both the first and second surface portions.

### Example 5

The cathode active material from Comparative Example 3, after the first sintering, was mixed with 0.5 wt % SiO₂ using a 30 L powder mixer at 1000 rpm for 30 minutes, then sintered at 600 °C for 10 hours to form both the first and second surface portions.

### Example 6

The cathode active material from Comparative Example 4, after the first sintering, was mixed with 0.5 wt % SiO₂ using a 30 L powder mixer at 1000 rpm for 30 minutes, then sintered at 450 °C for 10 hours to form both the first and second surface portions.

### Example 7

The cathode active material from Comparative Example 4, after the first sintering, was mixed with 0.5 wt % SiO₂ using a 30 L powder mixer at 1000 rpm for 30 minutes, then sintered at 600 °C for 20 hours to form both the first and second surface portions.

### Example 8

The cathode active material from Comparative Example 4, after the first sintering, was mixed with 0.5 wt % SiO₂ using a 30 L powder mixer at 1000 rpm for 30 minutes, then sintered at 600 °C for 10 hours to form both the first and second surface portions.

### Example 9

The cathode active material from Comparative Example 4, after the first sintering, was mixed with 1 wt % SiO₂ using a 30 L powder mixer at 1000 rpm for 30 minutes, then sintered at 600 °C for 10 hours to form both the first and second surface portions.

### Example 10

The cathode active material from Comparative Example 4, after the first sintering, was mixed with 2 wt % SiO₂ using a 30 L powder mixer at 1000 rpm for 30 minutes, then sintered at 600 °C for 10 hours to form both the first and second surface portions.

### Example 11

The cathode active material from Comparative Example 5, after the first sintering, was mixed with 0.5 wt % SiO₂ using a 30 L powder mixer at 1000 rpm for 30 minutes, then sintered at 600 °C for 10 hours to form both the first and second surface portions.

### Example 12

The cathode active material from Comparative Example 6, after the first sintering, was mixed with 0.5 wt % SiO₂ using a 30 L powder mixer at 1000 rpm for 30 minutes, then sintered at 600 °C for 10 hours to form both the first and second surface portions.

### Experimental Example 1—SEM Analysis

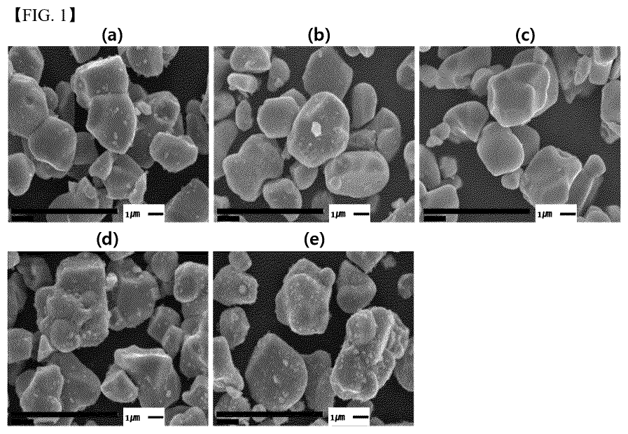

SEM analysis was performed on the cathode active materials produced in Comparative Examples 11, 12 and Examples 8, 9, 10 under the following conditions, and the results are shown in FIG. 1.

### [SEM Measurement Conditions]

Model: HITACHI (S-4800)
Resolution: 1.0 nm 15 kV, 1.5 nm 1 kV
Magnification: ×10,000
Electron gun: Cold-cathode field emission type electron gun
Accelerating voltage: 10 kV
Detector: SE (BSE).

Referring to FIG. 1, the structure of Example 8, where both the first surface portion and the second surface portion are simultaneously formed, can be observed in (a). The structure of Comparative Example 11, where only the first surface portion is present, can be seen in (b), while the structure of Comparative Example 12, where only the second surface portion is present, is shown in (c).

Additionally, when comparing the SEM images of Example 8, Example 9 (d), and Example 10 (e), it can be confirmed that as the Si content increases, the first surface portion becomes thicker.

### Experimental Example 2—FE-TEM and EDS Mapping Analysis

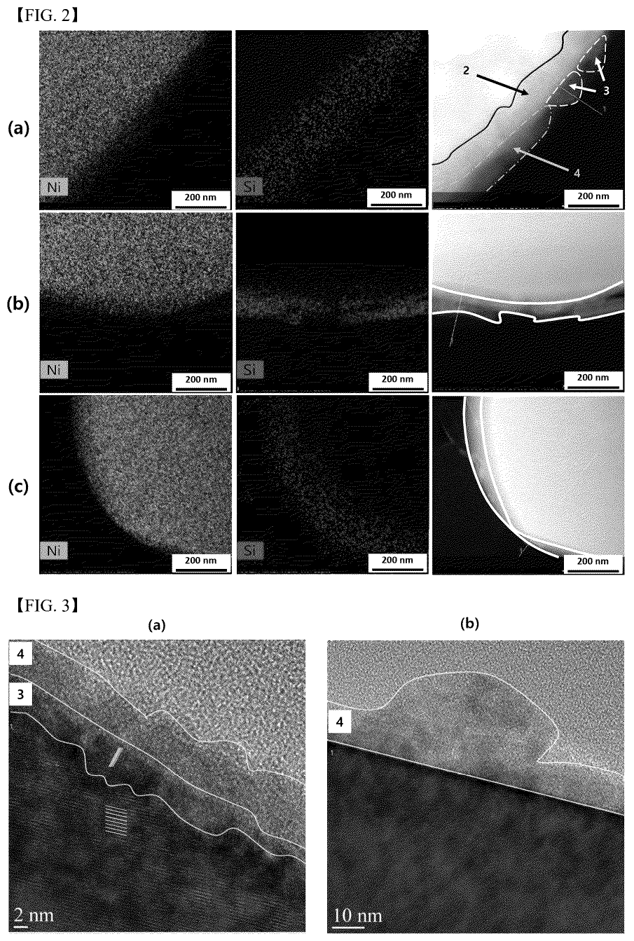

For FE-TEM analysis of the cathode active materials produced in Comparative Examples 11, 12 and Example 8, cross-sections were prepared using a Focused Ion Beam (FIB) and analyzed under the following conditions, and the results are shown in FIG. 2.

### [FE-TEM Measurement Conditions]

Electron Gun Type: High brightness Schottky FEG (X-FEG)
Acceleration Voltage: 80~200 kV
Cs Correction: Probe Cs-corrector
TEM Resolution: 0.24 nm
Information Limit with Probe Cs: 0.11 nm
STEM Resolution with Probe Cs: 0.08 nm
EDS: 4 SDDs, windowless (Super-X).

Referring to FIG. 2, the positions of the first and second surface portions can be identified.
(a) represents the TEM image and mapping image of Example 8. In the TEM image, it is evident that both the first surface portion, which is formed outward from the interface of the core, and the second surface portion, which contains Si and is formed inward from the core interface, are present. Upon examining the first surface portion, it was found to contain both crystalline regions, corresponding to Chemical Formula 3, in a spot-like morphology, and amorphous regions, corresponding to Chemical Formula 4, coexisting within the layer. The second surface portion of Example 8 appears relatively brighter compared to the first surface portion. However, due to the minimal contrast difference with the core, distinguishing it may be challenging. Nevertheless, by comparing it with the EDS mapping image, the presence of the Si-containing second surface portion, formed inward from the core interface, can be confirmed.

In contrast, in (b), corresponding to Comparative Example 11, only the first surface portion is observed, while the second surface portion is absent.

Similarly, in (c), corresponding to Comparative Example 12, the TEM image reveals that the first surface portion is not formed, and only the Si-containing second surface portion is present.

FIG. 3 presents the high-resolution TEM images of Example 8 (a) and Comparative Example 11 (b).

Specifically, in these TEM images, the presence of crystalline regions based on the elemental composition of Chemical Formula 3 and amorphous regions based on Chemical Formula 4 within the first surface portion can be identified.

First, in (a), the first surface portion contains both crystalline regions corresponding to the elemental composition of Chemical Formula 3 (denoted as Region 3) and amorphous regions corresponding to the elemental composition of Chemical Formula 4 (denoted as Region 4). It is confirmed that these crystalline and amorphous structures are coexisting. It is noted that the second surface portion could not be observed in this image since it shares the same phase as the core.

In contrast, in (b), only the amorphous region corresponding to the elemental composition of Chemical Formula 4 is present in the first surface portion.

### Experimental Example 3—XRD Analysis

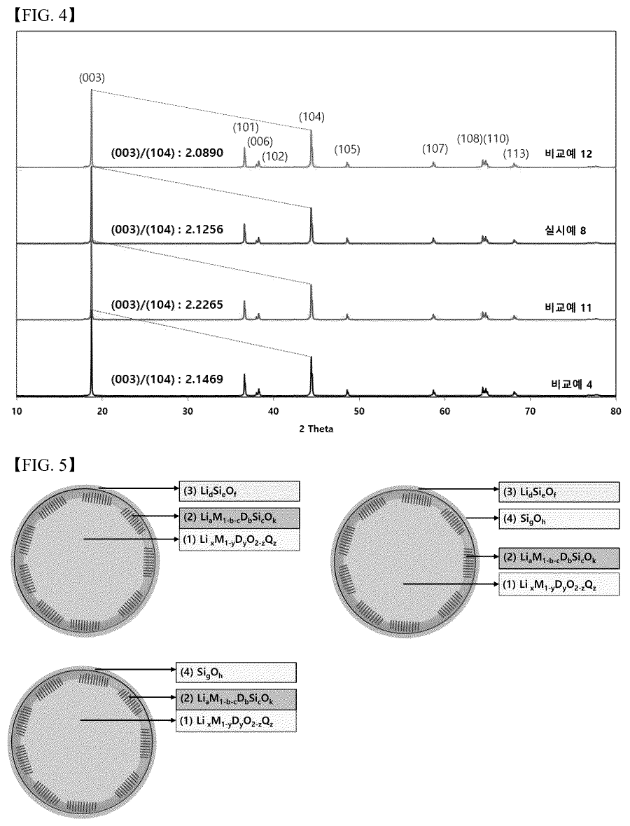

XRD patterns of the cathode active materials produced in Comparative Examples 4, 11, 12 and Example 8 were measured under the following conditions, and the results are shown in FIG. 4.

### [XRD Measurement Conditions]

X-ray Source: Cu Kα (fine focus), wavelength: 1.541836 Å
Goniometer: 2θ/θ mode, Measurement Method: Continuous, Count Unit: cps
Starting Angle: 10.0°, Ending Angle: 120.0°
Accumulation Count: 1 time
Sampling Width: 0.01°, Scan Speed: 1.3°/min
Voltage: 40 kV, Current: 40 mA
Divergence Slit: 0.2 mm, Receiving Slit: 10 mm
Scatter Slit: Open, Detector Slit: Open
Offset Angle: 0°
Goniometer Radius: 285 mm, Optics: Focused
Attachment: ASC-48
Slit: For D/teX Ultra
Detector: D/teX Ultra
Incident Monochromator: CBO
Ni-Kβ Filter: None
Rotation Speed: 30 rpm

In the XRD pattern of FIG. 4, it can be confirmed that the active material was produced without impurities. The R-factor values for Comparative Examples 4, 11, and 12 are 0.5644, 0.5742, and 0.5528, respectively, while Example 8 shows an R-factor value of 0.5489. The R-factor is an indicator of crystallinity, with smaller values indicating increased crystallinity of the hexagonal structure. From these results, it can be concluded that Example 8 has the best crystallinity among the comparative groups.

In the (003)/(104) ratio analysis, Comparative Example 4 shows a value of 2.1469, while Comparative Example 11, Example 8, and Comparative Example 12 show values of 2.2265, 2.1256, and 2.0890, respectively, indicating a progressive decrease. The (003)/(104) ratio is related to the layered structure on the surface of the cathode active material, and as more Si penetrates the layered structure, the ratio is expected to decrease, which aligns with the observed trend in the results. In the case of Comparative Example 12, it is presumed that an excessive amount of Si penetrated into the interior through the second surface portion.

### Experimental Example 4—ICP Analysis

ICP (Inductively Coupled Plasma) analysis was performed under the following conditions to measure the Si content in the cathode active materials produced in Examples 8-10.

### [ICP Measurement Conditions]

Instrument: Perkin Elmer Optima, Avio
Electronic Balance: approximately 0.1 mg
\textcircled{1} Approximately 0.8±0.001 g of sample is placed in a glass beaker.
\textcircled{2} 5 mL of aqua regia is added to both a blank and the sample-containing beaker; the mixture is heated on a hot plate at 250 °C for 30 minutes.
\textcircled{3} The boiled solution is transferred into a 200 mL round flask using ultrapure water until the calibration mark is reached (resulting in a 250× dilution).
\textcircled{4} The pre-treated sample is quantitatively analyzed by ICP.

Based on the measured Si content, the amount of lithium silicon oxide or silicon oxide included in the first and second surface portions was back-calculated. As a result, Example 8 was found to have a Si content of 0.5 wt % relative to the total weight of the lithium transition metal oxide. Example 9 and Example 10 were calculated to have Si contents of 1 wt % and 2 wt %, respectively.

### Experimental Example 5—Electrochemical Analysis

The cathode active materials produced in Comparative Examples 1-12 and Examples 1-12 were mixed with a conductive agent (Super-P) and a binder (PVDF) in N-methyl-2-pyrrolidone at a weight ratio of 96:2:2 to form a cathode slurry, which was then coated onto an aluminum current collector, dried at 120 °C, and calendared to form a cathode.

Using the prepared cathode with a lithium metal anode and a porous polyethylene separator, electrode assemblies were prepared and assembled into battery cases; electrolyte was then injected into the battery case to produce lithium secondary batteries. The electrolyte used was an organic solvent consisting of a 1:1 (by volume) mixture of ethylene carbonate (EC) and dimethyl carbonate (DMC) with 1.0 M lithium hexafluorophosphate (LiPF₆) dissolved therein.

### \textcircled{1} Resistance:

Each battery was subjected to charge-discharge tests at 0.1C, 4.25V (charge) and 0.1C, 2.5V (discharge). The resistance was calculated (R=V/I) from the voltage change during the initial 0-65 seconds of discharge. The results are shown in Table 1.

### \textcircled{2} Measurement of Cycle Life and Resistance Increase Rate:

Batteries were cycled at 0.5C, 4.25V (charge) and 1.0C, 2.5V (discharge) at 45 °C for 50 cycles; cycle life and resistance increase rate were measured and are shown in Table 1.

### Experimental Example 6—Residual Lithium Measurement

Residual lithium in the cathode active materials from Comparative Examples 1-12 and Examples 1-12 was measured under the following conditions, and the results are summarized in Table 1.

### \textcircled{1} Sample Pre-Treatment:

5±0.01 g of sample is mixed with 100 g of distilled water in a conical beaker containing a magnetic stir bar and stirred for 5 minutes.
The stirred sample is filtered naturally using filter paper.
The filtrate is collected in a beaker and titrated.

### \textcircled{2} Test Method:

After filling the titrator with the titrant solution (0.1N HCl), air bubbles are removed from the cylinder.
titrant: 0.1N HCl
Titrant dispensing method: DET
   Calculation: FP(1)=4.5, EP(1)
   Titration rate: Maximum.

[ [symbol] 1]

| | 0.2/0.2 C FM | | | | 50 CY | | Residual |
|---|---|---|---|---|---|---|---|
| | CC | DC | Eff | DCIR | Retention | DCIR | Li |
| | (mAh/g) | (mAh/g) | (%) | (Ohm) | (%) | (%) | (%) |
| Comp. | 220.4 | 193.8 | 87.9 | 17.1 | 90.7 | 122.1 | 0.325 |
| Ex. 1 | | | | | | | |
| Comp. | 230.7 | 202.6 | 87.8 | 17.9 | 90.4 | 112.7 | 0.436 |
| Ex. 2 | | | | | | | |
| Comp. | 229.5 | 200.6 | 87.4 | 16.2 | 89.6 | 118.3 | 0.418 |
| Ex. 3 | | | | | | | |
| Comp. | 244 | 213.3 | 87.4 | 24.9 | 89.5 | 70 | 0.738 |
| Ex. 4 | | | | | | | |
| Comp. | 228 | 202 | 88.6 | 40.3 | 87.7 | 83 | 0.932 |
| Ex. 5 | | | | | | | |
| Comp. | 238 | 209.4 | 88 | 48.6 | 88.1 | 89.4 | 0.917 |
| Ex. 6 | | | | | | | |
| Comp. | 243.2 | 208.4 | 85.7 | 27.1 | 89.0 | 87.5 | 0.750 |
| Ex. 7 | | | | | | | |
| Comp. | 243.4 | 208.4 | 85.6 | 26.9 | 91.2 | 88.4 | 0.751 |
| Ex. 8 | | | | | | | |
| Comp. | 242.7 | 208.2 | 85.8 | 24.2 | 91.3 | 84.2 | 0.630 |
| Ex. 9 | | | | | | | |
| Comp. | 221.8 | 195.8 | 88.3 | 18.5 | 93.8 | 144.0 | 0.270 |
| Ex. 7 | | | | | | | |
| Comp. | 220.9 | 196.2 | 89.1 | 14.9 | 92.4 | 138.7 | 0.222 |
| Ex. 8 | | | | | | | |
| Comp. | 230.7 | 199.6 | 86.5 | 20 | 92.3 | 121.8 | 0.407 |
| Ex. 9 | | | | | | | |
| Comp. | 227.3 | 202.3 | 89.0 | 14.4 | 91.0 | 114.3 | 0.300 |
| Ex. 10 | | | | | | | |
| Comp. | 244.2 | 211.5 | 86.6 | 27.2 | 92.5 | 90.5 | 0.636 |
| Ex. 11 | | | | | | | |
| Comp. | 242.4 | 213.3 | 88 | 21.3 | 90.8 | 90.6 | 0.502 |
| Ex. 12 | | | | | | | |
| Ex. 1 | 222.1 | 196.6 | 88.5 | 15.6 | 95.2 | 89.2 | 0.244 |
| Ex. 2 | 231.1 | 201.5 | 87.2 | 18.3 | 92.6 | 108.1 | 0.382 |
| Ex. 3 | 228.9 | 203.0 | 88.7 | 15.3 | 91.8 | 95.9 | 0.319 |
| Ex. 4 | 231.9 | 205.5 | 88.6 | 15.5 | 93.9 | 78.5 | 0.336 |
| Ex. 5 | 230.2 | 202.8 | 88.1 | 14.4 | 93.5 | 87.1 | 0.304 |
| Ex. 6 | 244.6 | 212.6 | 86.9 | 25.8 | 93.1 | 82.7 | 0.599 |
| Ex. 7 | 243.8 | 214.1 | 87.8 | 22.0 | 91.6 | 70.5 | 0.522 |
| Ex. 8 | 245.2 | 216.0 | 88.1 | 22.3 | 93.8 | 55.3 | 0.558 |
| Ex. 9 | 243.7 | 211.3 | 86.7 | 25 | 90.0 | 99.7 | 0.682 |
| Ex. 10 | 240.3 | 204.5 | 85.1 | 29.4 | 87.3 | 156.7 | 0.76 |
| Ex. 11 | 230 | 212.3 | 92.3 | 33.7 | 92.4 | 83.5 | 0.812 |
| Ex. 12 | 243 | 223.3 | 91.9 | 40.1 | 92.2 | 67.2 | 0.793 |

As shown in Table 1, when comparing Comparative Examples 1, 2, and 4 (where neither the first nor the second surface portion was formed) with Comparative Examples 7, 9, and 11 (where only the first surface portion was formed), improvements in charging capacity, lifespan, and residual lithium due to the formation of the first surface portion were observed. The first surface portion is expected to be closer in composition to the element composition of Chemical Formula 4, which is relatively less reactive with lithium.

Additionally, when comparing Comparative Examples 1, 2, and 4 with Comparative Examples 8, 10, and 12 (where only the second surface portion was formed), improvements in efficiency, resistance, and residual lithium due to the second surface portion were identified. However, when only the first surface portion was formed, efficiency tended to decrease compared to cases where neither surface portion was formed, and resistance increased. Similarly, when only the second surface portion was formed, improvements in charge-discharge capacity and lifespan were minimal.

In contrast, in Examples 3 and 7, where both the second surface portion and the first surface portion, including the lithium compound of Chemical Formula 3, were formed, significant improvements were observed. Specifically, Example 3, compared to Comparative Example 9 (where only the first surface portion was formed), showed better performance in efficiency, residual lithium, and resistance. Compared to Comparative Example 10 (where only the second surface portion was formed), Example 3 exhibited superior charge-discharge efficiency and lifespan characteristics. This suggests that the synergistic effect of the proper balance between the first and second surface portions plays a crucial role.

Similarly, in Examples 2 and 6, where a second surface portion formed relatively quickly due to the instability of the active material surface and where the first surface portion contained the element composition of Chemical Formula 4 that has not reacted with lithium, Example 6 showed superior characteristics compared to Comparative Example 11 (where only the first surface portion was formed) and Comparative Example 12 (where only the second surface portion was formed).

Furthermore, Examples 1, 4, 5, 8, 9, and 10, in which both the first surface portion and the second surface portions with the element compositions of Chemical Formulas 3 and 4 are included, exhibited the best improvements in charging capacity, efficiency, resistance, and lifespan compared to all comparative examples. Notably, when comparing Examples 8, 9, and 10, despite having the same composition ratio, Example 8 exhibited superior performance, which is believed to be due to differences in Si content. While all showed improvements over the comparative examples, optimizing the Si content could further enhance performance.

Furthermore, in the case of Comparative Examples 5 and 6 and Examples 11 and 12, which have agglomerated clusters of primary particles, it can be seen from the experimental results that Examples 11 and 12, which include both the first surface portion and the second surface portions with the elemental compositions of the Chemical Formulas 3 and 4, exhibit superior characteristics compared to Comparative Examples 5 and 6.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A cathode active material comprising:
a core that includes a transition metal oxide;
a first surface portion formed in an outward direction from the interface of the core; and
a second surface portion formed in an inward direction from the interface of the core;
wherein both the first and second surface portions include Si.

2. The cathode active material according to claim 1, wherein the transition metal oxide includes the elemental composition represented by the following Chemical Formula 1:
AₓM_{1-y}D_{y}O_{2-z}Q_{z} (1)
wherein:
A represents one or more elements selected from alkali metals;
M represents one or more transition metal elements stable in four-coordinate or six-coordinate system;
D represents one or more elements selected from alkali earth metals, transition metals, or non-metals as dopants; and
Q represents an anion including one or more elements selected from F, S, and P;
with 0.35≤x≤1.1, 0≤y≤0.1, and 0≤z≤0.2.

3. The cathode active material according to claim 2, wherein M comprises Ni at 70 mol % or more based on the total transition metal content in the core.

4. The cathode active material according to claim 1, wherein the second surface portion includes the elemental composition represented by Chemical Formula 2 and the first surface portion includes the elemental composition represented by Chemical Formula 3:
AₐM_{1-b-c}D_{b}Si_{c}Oₖ (2)
wherein:
A represents one or more elements selected from alkali metals;
M represents one or more transition metal elements stable in four-coordinate or six-coordinate system;
D represents one or more elements selected from alkali earth metals, transition metals, or non-metals used as dopants;
Q represents an anion including one or more elements selected from F, S, and P;
with 0.35≤a≤1.1, 0≤b≤0.1, 0<c≤0.1, and 0<k≤4, and
A_{d}SiₑO_{f} (3)
wherein:
A represents one or more elements selected from alkali metals;
1≤d≤8, 1≤e≤2, and 0≤f≤6.

5. The cathode active material according to claim 1, wherein the second surface portion includes the elemental composition represented by Chemical Formula 2 and the first surface portion includes the elemental composition represented by Chemical Formula 4:
AₐM_{1-b-c}D_{b}Si_{c}Oₖ (2)
wherein:
A represents one or more elements selected from alkali metals;
M represents one or more transition metal elements stable in four-coordinate or six-coordinate system;
D represents one or more elements selected from alkali earth metals, transition metals, or non-metals as dopants;
Q represents an anion including one or more elements selected from F, S, and P;
with 0.35≤a≤1.1, 0≤b≤0.1, 0<c≤0.1, 0<k≤4, and
Si_{g}Oₕ (4)
wherein 1≤g≤2 and 1≤h≤4.

6. The cathode active material according to claim 1, wherein the second surface portion includes the elemental composition represented by Chemical Formula 2 and the first surface portion simultaneously includes the elemental compositions represented by Chemical Formulas 3 and 4:
AₐM_{1-b-c}D_{b}Si_{c}Oₖ (2)
wherein:
A represents one or more elements selected from alkali metals;
M represents one or more transition metal elements stable in four-coordinate or six-coordinate system;
D represents one or more elements selected from alkali earth metals, transition metals, or non-metals as dopants;
Q represents an anion including one or more elements selected from F, S, and P;
with 0.35≤a≤1.1, 0≤b≤0.1, 0<c≤0.1, and 0<k≤4, and
A_{d}SiₑO_{f} (3)
wherein
A represents one or more alkali metal elements;
1≤d≤8, 1≤e≤2, 0≤f≤6, and
Si_{g}Oₕ (4)
wherein 1≤g 2 and 2≤h≤4.

7. The cathode active material according to claim 4, wherein the first surface portion has a relatively higher proportion of a crystalline region.

8. The cathode active material according to claim 4, wherein the first surface portion includes at least one selected from Li₂SiO₃, Li₄SiO₄, Li₈SiO₆, and LiSi.

9. The cathode active material according to claim 5, wherein the first surface portion has a relatively higher proportion of an amorphous region.

10. The cathode active material according to claim 5, wherein the first surface portion includes at least one selected from SiO₂ and Si₂O₄.

11. The cathode active material according to claim 1, wherein the transition metal oxide comprises a cluster of a plurality of primary particles.

12. The cathode active material according to claim 1, wherein, when analyzed under the following ICP measurement conditions, the Si content is 2 wt % or less:
[ICP Measurement Conditions]
Instrument: Perkin Elmer Optima, Avio
Electronic balance: approximately 0.1 mg
Pre-treatment: Sinter on a hot plate at 250 °C for 30 minutes, then dilute 250 times with ultrapure water.

13. The cathode active material according to claim 1, wherein, when measured in any four regions under the following SEM measurement conditions, the average primary particle size of the core is 1 μm or more:
[SEM Measurement Conditions]
Model: HITACHI (S-4800)
Resolution: 1.0 nm at 15 kV, 1.5 nm at 1 kV
Magnification: ×10,000
Electron Gun: Cold-cathode field emission type electron gun
Accelerating Voltage: 10 kV
Detector: SE (BSE).

14. A secondary battery comprising the cathode active material according to claim 1.
